(19) United States
(12) Patent Application Publication
(10) Pub. No.: US 2024/0298318 A1
(43) Pub. Date: Sep. 5, 2024

(54) NETWORK NODE, WIRELESS DEVICE AND METHODS THEREIN FOR WIRELESS COMMUNICATION

(71) Applicant: Telefonaktiebolaget LM Ericsson (publ), Stockholm (SE)

(72) Inventors: Mattias ANDERSSON, Sundbyberg (SE); Kittipong KITTICHOKECHAI, Järfälla (SE); Sorour FALAHATI, Stockholm (SE); Bikramjit SINGH, Raasepori (FI)

(21) Appl. No.: 18/261,737

(22) PCT Filed: Jan. 18, 2022
(86) PCT No.: PCT/SE2022/050053

§ 371 Date: Jul. 17, 2023

Related U.S. Application Data
(60) Provisional application No. 63/138,579, filed on Jan. 18, 2021.

(51) Int. Cl. H04W 72/1273; H04L 1/1812; H04W 72/0446; H04W 72/11

(52) U.S. Cl. CPC H04W 72/1273; H04L 1/1812; H04W 72/0446; H04W 72/11

(57) ABSTRACT

A method, network node and wireless device (WD) for deferring semipersistent scheduling (SPS) hybrid automatic repeat request acknowledgements (HARQ-ACK) are disclosed. According to one aspect, a method in a network node includes configuring the WD to defer SPS HARQ-ACK to a slot subsequent to slot n+K1 when slot n+K1 is invalid for SPS HARQ-ACK transmission, n being a slot index indicating a downlink slot, and K1 being a fixed offset indicating a slot for transmission of a HARQ-ACK in response to a physical downlink shared channel, PDSCH, scheduled for the WD in slot n.

### TECHNICAL FIELD

The present disclosure relates to wireless communications, and in particular, to deferring semipersistent scheduling (SPS) hybrid automatic repeat request acknowledgements (HARQ-ACK).

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs.

The New Radio (NR) standard in 3GPP is designed to provide service for multiple use cases such as enhanced mobile broadband (eMBB), ultra-reliable and low latency communication (URLLC), and machine type communication (MTC). Each of these services has different technical requirements. For example, the general requirement for eMBB is high data rate with moderate latency and moderate coverage, while URLLC service requires a low latency and high reliability transmission but perhaps for moderate data rates.

One of the solutions for low latency data transmission is shorter transmission time intervals. In NR, in addition to transmission in a slot, a mini-slot transmission is also allowed to reduce latency. A mini-slot is a concept that is used in scheduling and in the downlink (DL). A mini-slot can consist of 2, 4 or 7 orthogonal frequency division multiplexed (OFDM) symbols, while in the uplink (UL), a mini-slot can be any number of 1 to 14 OFDM symbols. It should be noted that the concepts of slot and mini-slot are not specific to a specific service meaning that a mini-slot may be used for either eMBB, URLLC, or other services. See FIG. 1.

In the 3GPP NR standard, downlink control information (DCI) transmitted in the physical downlink control channel (PDCCH), is used to indicate the DL data related information, uplink (UL) related information, power control information, slot format indication, etc. There are different formats of DCI associated with each of these control signals and the WD identifies them based on different radio network temporary identifiers (RNTIs).

A WD is configured by higher layer signaling to monitor for DCIs in different resources with different periodicities, etc. DCI formats 1_0, 1_1, and 1_2 are used for scheduling DL data which is sent in the physical downlink shared channel (PDSCH), and includes time and frequency resources for DL transmission, as well as modulation and coding information, hybrid automatic repeat request (HARQ) information, etc.

In case of DL semi-persistent scheduling (SPS) and UL configured grant type 2, part of the scheduling, including the periodicity, is provided by the higher layer configurations, while the rest of scheduling information, such as time domain and frequency domain resource allocation, modulation and coding, etc., are provided by the DCI in the PDCCH.

### Uplink Control Information

Uplink control information (UCI) is a control information sent by a WD to a gNB (NR base station), herein referred to as a network node. UCI may include at least one of the following:
A Hybrid-ARQ acknowledgement (HARQ-ACK), which is feedback information corresponding to the received downlink transport block indicating whether the transport block reception is successful or not;
Channel state information (CSI) related to downlink channel conditions which provides the network node with channel-related information useful for DL scheduling, including information for multi-antenna and beamforming schemes; and/or
A scheduling request (SR) which indicates a need of UL resources for UL data transmission.

UCI is typically transmitted on the physical uplink control channel (PUCCH). However, if a WD is transmitting data on the physical uplink shared channel (PUSCH) with a valid PUSCH resource overlapping with the PUCCH, UCI can be multiplexed with UL data and transmitted on the PUSCH instead, if the timeline requirements for UCI multiplexing are met.

### Physical Uplink Control Channel

The Physical Uplink Control Channel (PUCCH) is used by a WD to transmit a HARQ-ACK feedback message corresponding to the reception of DL data transmission. It is also used by the WD to send channel state information (CSI) or to request for an uplink grant for transmitting UL data.

In NR, there exists multiple PUCCH formats supporting different UCI payload sizes. PUCCH formats 0 and 1 support UCI up to 2 bits, while PUCCH formats 2, 3, and 4 can support UCI of more than 2 bits. In terms of PUCCH transmission duration, PUCCH formats 0 and 2 are considered short PUCCH formats supporting a PUCCH duration of 1 or 2 OFDM symbols, while PUCCH formats 1, 3, and 4 are considered to be long formats and can support a PUCCH duration from 4 to 14 symbols.

### HARQ Feedback

The procedure for receiving downlink transmission is that the WD first monitors and decodes a PDDCH in slot n, which points to a DL data scheduled in slot n+K0 slots (where K0 is larger than or equal to 0). The WD then decodes the data in the corresponding PDSCH. Finally, based on the outcome of the decoding, the WD sends an acknowledgement of the correct decoding (ACK) or a negative acknowledgement (NACK) to the network node at time slot n+K0+K1. In case of slot aggregation, n+K0 would be replaced by the slot where the PDSCH ends. Both K0 and K1 are indicated in the DCI. The resources for sending the acknowledgement are indicated by the PUCCH resource indicator (PRI) field in the DCI which points to one of PUCCH resources that are configured by higher layers.

Depending on DL/UL slot configurations, or whether carrier aggregation, or per code-block group (CBG) transmission is used in the DL, the feedback for several PDSCHs may need to be multiplexed into one feedback. This is done by constructing HARQ-ACK codebooks. In NR, the WD can be configured to multiplex the acknowledgment/non-acknowledgment (A/N) bits using a semi-static codebook or a dynamic codebook.

A Type 1 or semi-static codebook consists of a bit sequence where each element contains the A/N bit from a possible allocation in a certain slot, carrier, or transport block (TB). When the WD is configured with a CBG and/or a time-domain resource allocation (TDRA) table with multiple entries, multiple bits are generated per slot and transport block (TB). Note that the codebook is derived regardless of the actual PDSCH scheduling. The size and format of the semi-static codebook is preconfigured based on the mentioned parameters. A drawback of a semi-static HARQ ACK codebook is that the size is fixed, and regardless of whether there is a transmission or not, a bit is reserved in the feedback matrix.

In cases where the WD has a TDRA table with multiple time-domain resource allocation entries configured: the table is pruned (i.e., entries are removed based on a specified algorithm) to derive a TDRA table that only contains non-overlapping time-domain allocations. One bit is then reserved in the HARQ codebook (CB) for each non-overlapping entry (assuming a WD is capable of supporting reception of multiple PDSCHs in a slot).

To avoid reserving unnecessary bits in a semi-static HARQ codebook in NR, a WD can be configured to use a type 2 or dynamic HARQ codebook, where an A/N bit is present only if there is a corresponding transmission scheduled. To avoid any confusion between the network node and the WD about the number of PDSCHs for which the WD must send feedback, a counter downlink assignment indicator (DAI) field exists in the DL assignment, which denotes a cumulative number of {serving cell, PDCCH occasion} pairs in which a PDSCH is scheduled to a WD up to the current PDCCH. In addition to that, there is another field called total DAI, which when present shows the total number of {serving cell, PDCCH occasion} pairs up to (and including) all PDCCHs of the current PDCCH monitoring occasion. The timing for sending HARQ feedback is determined based on both the PDSCH transmission slot with reference to PDCCH slot (K0) and the PUCCH slot that contains HARQ feedback (K1).

FIG. 2 illustrates the timeline in a simple scenario with two PDSCHs and one feedback. In this example there is in total, 4 PUCCH resources configured, and the PUCCH resource indicator (PRI) indicates PUCCH 2 to be used for HARQ feedback. PUCCH 2 is selected from 4 PUCCH resources based on the procedure in 3GPP NR Technical Release 15 (3GPP Rel-15).

In 3GPP Rel-15, a WD can be configured with a maximum of 4 PUCCH resource sets for transmission of HARQ-ACK information. Each set is associated with a range of UCI payload bits including HARQ-ACK bits. The first set is always associated to 1 or 2 HARQ-ACK bits and hence, includes only PUCCH format 0 or 1 or both. The range of payload values (minimum of maximum values) for other sets, if configured, is provided by configuration, except for the maximum value for the last set where a default value is used, and the minimum value of the second set, which is 3. The first set can include a maximum of 32 PUCCH resources of PUCCH format 0 or 1. Other sets can include a maximum 8 bits of format 2 or 3 or 4.

As described previously, the WD determines a slot for transmission of HARQ-ACK bits in a PUCCH corresponding to PDSCHs scheduled or activated by DCI via the K₁ value provided by configuration or a field in the corresponding DCI. The WD forms a codebook from the HARQ-ACK bits with associated PUCCH in a same slot via corresponding K₁ values.

The WD determines a PUCCH resource set for which the size of the codebook is within the corresponding range of payload values associated to that set.

The WD determines a PUCCH resource in that set if the set is configured with a maximum of 8 PUCCH resources, by a field in the last DCI associated to the corresponding PDSCHs. If the set is the first set and is configured with more than 8 resources, a PUCCH resource in that set is determined by a field in the last DCI associated to the corresponding PDSCHs and implicit rules based on the control channel element (CCE).

A PUCCH resource for HARQ-ACK transmission can overlap in time with other PUCCH resources for CSI and/or scheduling request (SR) transmissions as well as PUSCH transmissions in a slot. In case of overlapping PUCCH and/or PUSCH resources, first the WD resolves overlapping between PUCCH resources, if any, by determining a PUCCH resource carrying the total UCI (including HARQ-ACK bits) such that the UCI multiplexing timeline requirements are met. There might be partial or complete dropping of CSI bits, if any, to multiplex the UCI in the determined PUCCH resource. Then, the WD resolves overlapping between PUCCH and PUSCH resources, if any, by multiplexing the UCI on the PUSCH resource if the timeline requirements for UCI multiplexing is met.

### Sub-Slot HARQ-ACK

In 3GPP NR Rel-16, an enhancement of HARQ-ACK feedback is made to support more than one PUCCH carrying HARQ-ACK in a slot for supporting different services and for possible fast HARQ-ACK feedback for URLLC. This leads to an introduction of new HARQ-ACK timing in a unit of sub-slot, i.e., a K1 indication in a unit of a sub-slot. Sub-slot configurations for PUCCH carrying HARQ-ACK can be configured from the two options, namely “2-symbol*7” and “7-symbol*2” for the sub-slot length of 2 symbols and 7 symbols, respectively. The indication of K1 is the same as that of 3GPP Rel-15. In other words, K1 is indicated in the DCI scheduling PDSCH. To determine the HARQ-ACK timing, there exists an association of PDSCH to sub-slot configuration so that if the scheduled PDSCH ends in sub-slot n, the corresponding HARQ-ACK is reported in sub-slot n+K1. In a sense, sub-slot based HARQ-ACK timing works similarly to that of the 3GPP Rel-15 slot-based procedure by replacing the unit of K1 from slot to sub-slot.

There exist some limitations on PUCCH resources for sub-slot HARQ-ACK. For example, only one PUCCH resource configuration is used for all sub-slots in a slot. Moreover, any PUCCH resource for sub-slot HARQ-ACK cannot cross sub-slot boundaries.

FIG. 3 shows an example where each PDSCH is associated with a certain sub-slot for HARQ feedback through the use of a K1 value in units of sub-slots.

### HARQ Feedback for Semi-Persistent Scheduling PDSCH

For a SPS PDSCH reception, the WD transmits HARQ-ACK feedback to the network node. The timing of the HARQ-ACK feedback is determined by a PDSCH-to-HARQ feedback timing indicator field, if present, in a DCI format activating the SPS PDSCH reception. Otherwise, the timing is provided by a higher layer parameter, dl-DataToUL-ACK.

PUCCH resource determination and HARQ-ACK codebook generation for SPS HARQ-ACK follow the procedure described above in the section entitled, “HARQ feedback.”

Once the HARQ-ACK timing, say K1, is indicated or configured for a SPS configuration, it is applied to all SPS PDSCH occasions of the activated SPS configuration.

In time division duplex (TDD) operation with an asymmetric DL/UL TDD pattern, if short SPS periodicity is used, it can happen that the SPS periodicity value does not match the TDD pattern, when it comes to HARQ-ACK feedback timing. It may happen that the HARQ-ACK timing value K1 does not indicate a valid UL slot for all SPS PDSCH occasions. This is illustrated in FIG. 4 with a single SPS configuration with periodicity of 1 slot where the indicated K1 does not match with the ‘DDDU’ semi-static TDD pattern. With K1=3 slots, HARQ-ACK feedback for the second and third SPS occasions would fall into DL slots, and thus these HARQ-ACKs would be dropped.

A solution to the above issue has been proposed by allowing SPS HARQ-ACKs, which would otherwise be dropped, to be deferred to a next available UL slot. However, complete details as to how to support the solution are still unknown, e.g., how to determine the first available UL slot to use for deferred SPS HARQ-ACK, how to perform multiplexing, how to generate a HARQ-ACK codebook supporting the deferred SPS HARQ-ACK, etc.

### SUMMARY

Some embodiments advantageously provide methods, network nodes, and WDs for deferring semipersistent scheduling (SPS) hybrid automatic repeat request acknowledgements (HARQ-ACK).

Some embodiments provide methods to fully support SPS HARQ-ACK deferring in case the SPS HARQ-ACK would collide with invalid slot/symbols as a result of mismatch between SPS periodicity and time division duplex (TDD) pattern.

Some embodiments provide solutions to determine the first available uplink (UL) slot to use for the deferred SPS HARQ-ACK in a flexible manner by allowing configuration of a set of invalid resources to control which resources can or cannot be used by the deferred HARQ-ACK.

Some embodiments allow for a full support of SPS HARQ-ACK deferring in TDD in a flexible manner.

According to one aspect, a network node is configured to communicate with a wireless device, WD, and includes processing circuitry configured to: configure the WD to configure the WD to defer semi-persistent scheduling, SPS, hybrid automatic repeat request acknowledgement, HARQ-ACK, to a slot subsequent to a slot n+K1 when slot n+K1 is invalid for SPS HARQ-ACK transmission, n being a slot index indicating a downlink slot, and K1 being a fixed offset indicating a slot for transmission of a HARQ-ACK in response to a physical downlink shared channel, PDSCH, scheduled for the WD in slot n.

According to this aspect, in some embodiments, deferral of SPS HARQ-ACK is limited to a predetermined maximum number of slots. In some embodiments, the processing circuitry is further configured to indicate to the WD a subset of symbols in a slot as invalid for deferred SPS HARQ-ACK. In some embodiments, the subset of invalid symbols are configured per WD. In some embodiments, the subset of invalid symbols are configured per SPS configuration. In some embodiments, a slot format indication, SFI, is disabled from causing the SPS HARQ-ACK deferring. In some embodiments, the processing circuitry is further configured to receive deferred SPS HARQ-ACK bits that are multiplexed with other HARQ-ACK bits in response to multiple transmissions to the WD. In some embodiments, the processing circuitry is further configured to determine a physical uplink control channel, PUCCH, resource based at least in part on a total size of a payload of multiplexed HARQ-ACK bits. In some embodiments, the processing circuitry is configured to configure the WD to drop deferred SPS HARQ-ACK when the WD cannot transmit on a physical uplink control channel, PUCCH, resource within a slot to which the SPS HARQ-ACK is deferred. In some embodiments, a slot to which the SPS HARQ-ACK is deferred is a first available slot subsequent to slot n+K1. In some embodiments, a fraction of SPS HARQ-ACK bits for a HARQ-ACK code book, CB, are deferred to a first available slot subsequent to slot n+K1 and a remainder of SPS HARQ-ACK bits for the HARQ-ACK CB are deferred to a slot subsequent to the first available slot.

According to another aspect, a method implemented in a network node configured to communicate with a wireless device, WD, includes: configuring the WD to defer semi-persistent scheduling, SPS, hybrid automatic repeat request acknowledgement, HARQ-ACK, to a slot subsequent to slot n+K1 when slot n+K1 is invalid for SPS HARQ-ACK transmission, n being a slot index indicating a downlink slot, and K1 being a fixed offset indicating a slot for transmission of a HARQ-in response to a physical downlink shared channel, PDSCH, scheduled for the WD in slot n.

According to this aspect, in some embodiments, deferral of SPS HARQ-ACK is limited to a predetermined maximum number of slots. In some embodiments, the method includes indicating to the WD a subset of symbols in a slot as invalid for deferred SPS HARQ-ACK. In some embodiments, the subset of invalid symbols are configured per WD. In some embodiments, the subset of invalid symbols are configured per SPS configuration. In some embodiments, a slot format indication, SFI, is disabled from causing the SPS HARQ-ACK deferring. In some embodiments, the method also includes receiving deferred SPS HARQ-ACK bits that are multiplexed with other HARQ-ACK bit in response to multiple transmissions to the WD. In some embodiments, the method also includes determining a physical uplink control channel, PUCCH, resource based at least in part on a total size of a payload of multiplexed HARQ-ACK bits. In some embodiments, the method also includes configuring the WD to drop deferred SPS HARQ-ACK when the WD cannot transmit on a physical uplink control channel, PUCCH, resource within a slot to which the SPS HARQ-ACK is deferred. In some embodiments, the subsequent slot is a first available slot subsequent to slot n+K1. In some embodiments, a fraction of SPS HARQ-ACK bits for a code book, CB, are deferred to a first available slot subsequent to slot n+K1 and a remainder of SPS HARQ-ACK bits for the HARQ-ACK CB are deferred to a slot subsequent to the first available slot.

According to yet another aspect, a WD configured to communicate with a network node includes processing circuitry configured to: defer semi-persistent scheduling, SPS, hybrid automatic repeat request acknowledgement, HARQ-ACK, to a slot subsequent to slot a n+K1 when slot n+K1 is invalid for SPS HARQ-ACK transmission, n being a slot index indicating a downlink slot and K1 being a fixed offset indicating a slot for transmission of a HARQ-ACK in response to a physical downlink shared channel, PDSCH, scheduled for the WD in slot n.

According to this aspect, in some embodiments, deferral of SPS HARQ-ACK is limited to a predetermined maximum number of slots. In some embodiments, the slot subsequent to the slot n+K1 is a first available slot that is not a downlink slot. In some embodiments, the processing circuitry is further configured to drop the SPS HARQ-ACK when the SPS HARQ-ACK cannot be transmitted before a slot n+K, where K>K1. In some embodiments, the processing circuitry is further configured to drop the deferred SPS HARQ-ACK when a PUCCH resource overlaps with invalid symbols. In some embodiments, the WD is further configured to multiplex deferred SPS HARQ-ACK bits with other HARQ-ACK bits in response to multiple transmissions received from the network node. In some embodiments, the WD is configured to determine a physical uplink control channel, PUCCH, resource based at least in part on a total size of a payload of multiplexed HARQ-ACK bits.

According to another aspect, a method implemented in a wireless device configured to communicate with a network node includes: deferring semi-persistent scheduling, SPS, hybrid automatic repeat request acknowledgement, HARQ-ACK, to a slot subsequent to slot a n+K1 when slot n+K1 is invalid for SPS HARQ-ACK transmission, n being a slot index indicating a downlink slot and K1 being a fixed offset indicating a slot for transmission of a HARQ-ACK in response to a physical downlink shared channel, PDSCH, scheduled for the WD in slot n.

According to this aspect, in some embodiments, deferral of SPS HARQ-ACK is limited to a predetermined maximum number of slots. In some embodiments, the slot subsequent to the slot n+K1 is a first available slot that is not a downlink slot. In some embodiments, the method includes dropping an SPS HARQ-ACK when the SPS HARQ-ACK cannot be transmitted before a slot n+K, where K>K1. In some embodiments, the method also includes dropping the deferred SPS HARQ-ACK when a PUCCH resource overlaps with invalid symbols. In some embodiments, the method also includes multiplexing deferred SPS HARQ-ACK bits with other HARQ-ACK bit in response to multiple transmissions received from the network node. In some embodiments, the method also includes determining a physical uplink control channel, PUCCH, resource based at least in part on a total size of a payload of multiplexed HARQ-ACK bits.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is an example radio resource in NR;

FIG. 2 is an example of a transmission timeline;

FIG. 3 is an illustration of K1 indications based on certain subslots;

FIG. 4 is an illustration of mismatch of SPS periodicity and TDD pattern with indicated K1;

FIG. 5 is a schematic diagram of an example network architecture illustrating a communication system connected via an intermediate network to a host computer according to the principles in the present disclosure;

FIG. 6 is a block diagram of a host computer communicating via a network node with a wireless device over an at least partially wireless connection according to some embodiments of the present disclosure;

FIG. 7 is a flowchart illustrating example methods implemented in a communication system including a host computer, a network node and a wireless device for executing a client application at a wireless device according to some embodiments of the present disclosure;

FIG. 8 is a flowchart illustrating example methods implemented in a communication system including a host computer, a network node and a wireless device for receiving user data at a wireless device according to some embodiments of the present disclosure;

FIG. 9 is a flowchart illustrating example methods implemented in a communication system including a host computer, a network node and a wireless device for receiving user data from the wireless device at a host computer according to some embodiments of the present disclosure;

FIG. 10 is a flowchart illustrating example methods implemented in a communication system including a host computer, a network node and a wireless device for receiving user data at a host computer according to some embodiments of the present disclosure;

FIG. 11 is a flowchart of an example process in a network node for deferring semipersistent scheduling (SPS) hybrid automatic repeat request acknowledgements (HARQ-ACK) according to some embodiments of the present disclosure;

FIG. 12 is a flowchart of an example process in a wireless device for deferring semipersistent scheduling (SPS) hybrid automatic repeat request acknowledgements (HARQ-ACK) according to some embodiments of the present disclosure;

FIG. 13 is a diagram of an example of a special slot;

FIG. 14 is a diagram of an example of SPS with one slot periodicity;

FIG. 15 is a diagram of an example of a TDD configuration where a subset of symbols in some slots are configured as invalid;

FIG. 16 is a diagram of an example of a TDD configuration where some slots are configured as invalid; and

FIG. 17 is a diagram of an example of deferring overflowing HARQ-ACK bits to a next possible valid PUCCH resource.

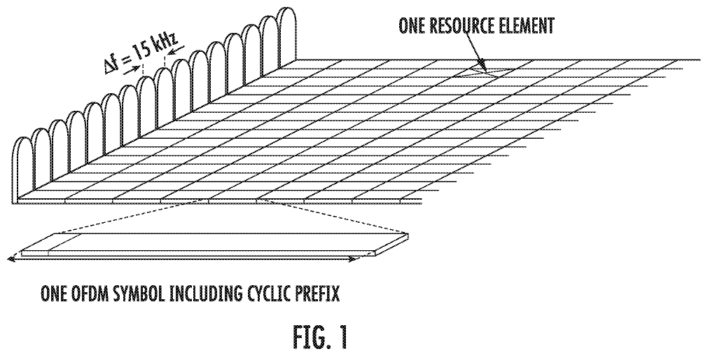

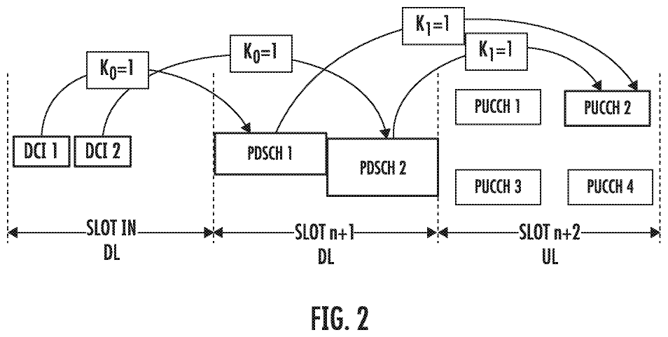

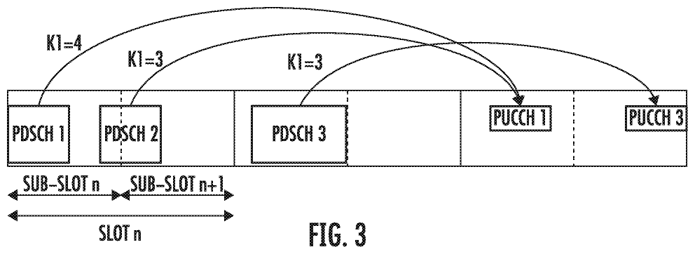

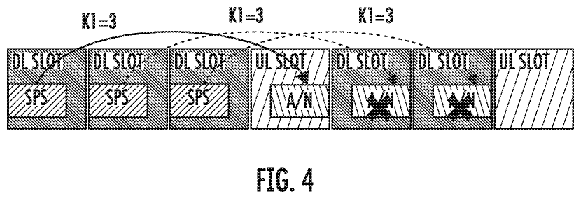

### DETAILED DESCRIPTION

Before describing in detail example embodiments, it is noted that the embodiments reside primarily in combinations of apparatus components and processing steps related to deferring semipersistent scheduling (SPS) hybrid automatic repeat request acknowledgements (HARQ-ACK). Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipment (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide for deferring semipersistent scheduling (SPS) hybrid automatic repeat request acknowledgements (HARQ-ACK).

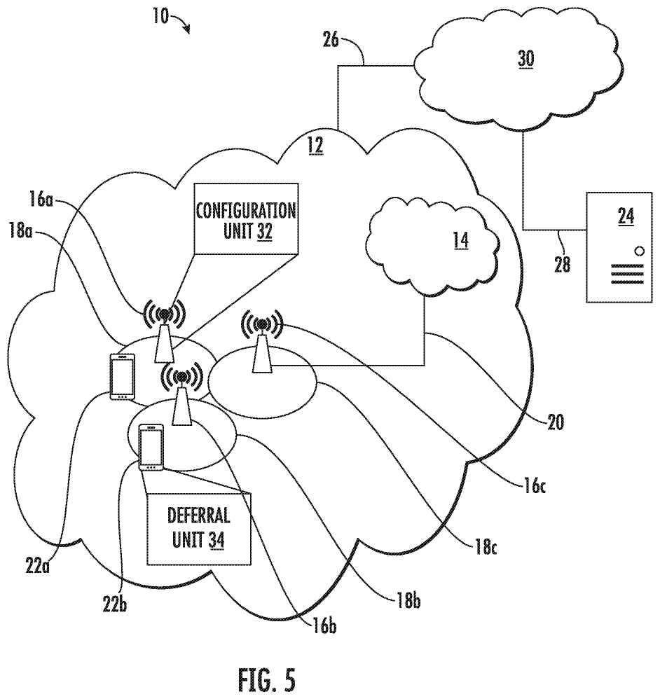

Returning now to the drawing figures, in which like elements are referred to by like reference numerals, there is shown in FIG. 5 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 5 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a configuration unit 32 which is configured to configure the WD to defer semi-persistent scheduling (SPS) hybrid automatic repeat request acknowledgement (HARQ-ACK) to a slot subsequent to slot n+K1 when slot n+K1 is a downlink slot, where n is a slot index indicating a downlink slot, and K1 is a fixed offset indicating a slot for transmission of a HARQ-ACK when the slot n+K1 is not a downlink slot.

A wireless device 22 is configured to include a deferral unit 34 which is configured to defer semi-persistent scheduling (SPS) hybrid automatic repeat request acknowledgement (HARQ-ACK) to a slot subsequent to slot n+K1 when slot n+K1 is a downlink slot, where n is a slot index indicating a downlink slot, and K1 is a fixed offset indicating a slot for transmission of a HARQ-ACK when the slot n+K1 is not a downlink slot.

Example implementations, in accordance with an embodiment, of the WD 22, network node 16 and host computer 24 discussed in the preceding paragraphs will now be described with reference to FIG. 6. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include configuration unit 32 which may be configured to configure the WD to defer semi-persistent scheduling (SPS) hybrid automatic repeat request acknowledgement (HARQ-ACK) to a slot subsequent to slot n+K1 when slot n+K1 is a downlink slot, where n is a slot index indicating a downlink slot, and K1 is a fixed offset indicating a slot for transmission of a HARQ-ACK when the slot n+K1 is not a downlink slot.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include deferral unit 34 which may be configured to defer semi-persistent scheduling (SPS) hybrid automatic repeat request acknowledgement (HARQ-ACK) to a slot subsequent to slot n+K1 when slot n+K1 is a downlink slot, where n is a slot index indicating a downlink slot, and K1 is a fixed offset indicating a slot for transmission of a HARQ-ACK when the slot n+K1 is not a downlink slot.

In FIG. 6, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending receipt of a transmission from the WD 22.

In some embodiments, the host computer 24 includes processing circuitry 42 and a communication interface 40 that is configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending receipt of a transmission from the network node 16.

Although FIGS. 5 and 6 show various “units” such as configuration unit 32 and deferral unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

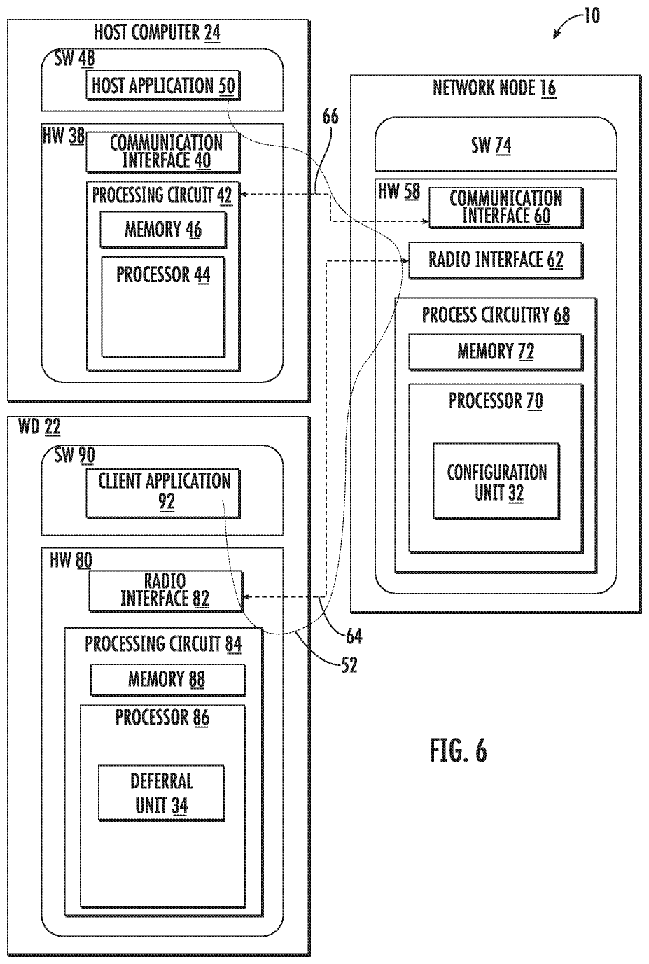

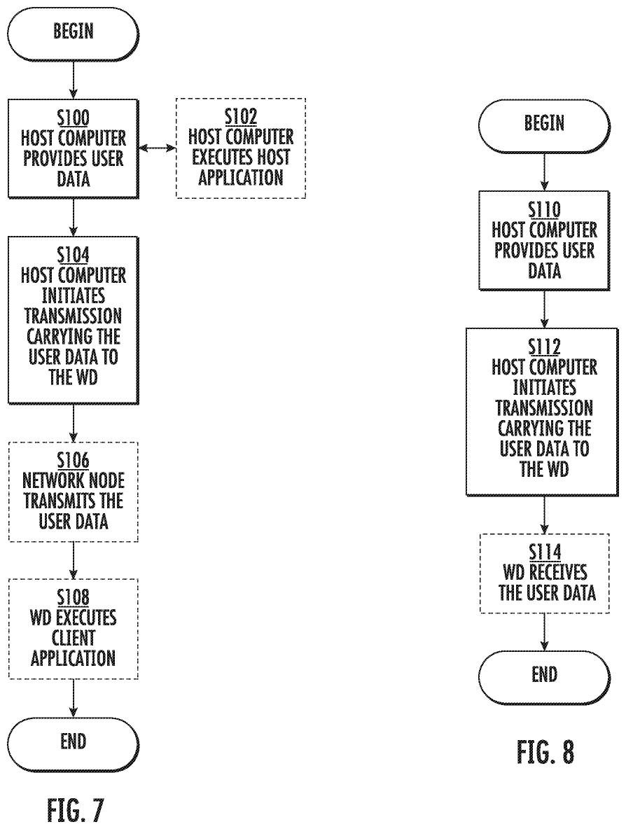

FIG. 7 is a flowchart illustrating an example method implemented in a communication system, such as, for example, the communication system of FIGS. 5 and 6, in accordance with one embodiment. The communication system may include a host computer 24, a network node 16 and a WD 22, which may be those described with reference to FIG. 6. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 8 is a flowchart illustrating an example method implemented in a communication system, such as, for example, the communication system of FIG. 5, in accordance with one embodiment. The communication system may include a host computer 24, a network node 16 and a WD 22, which may be those described with reference to FIGS. 5 and 6. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

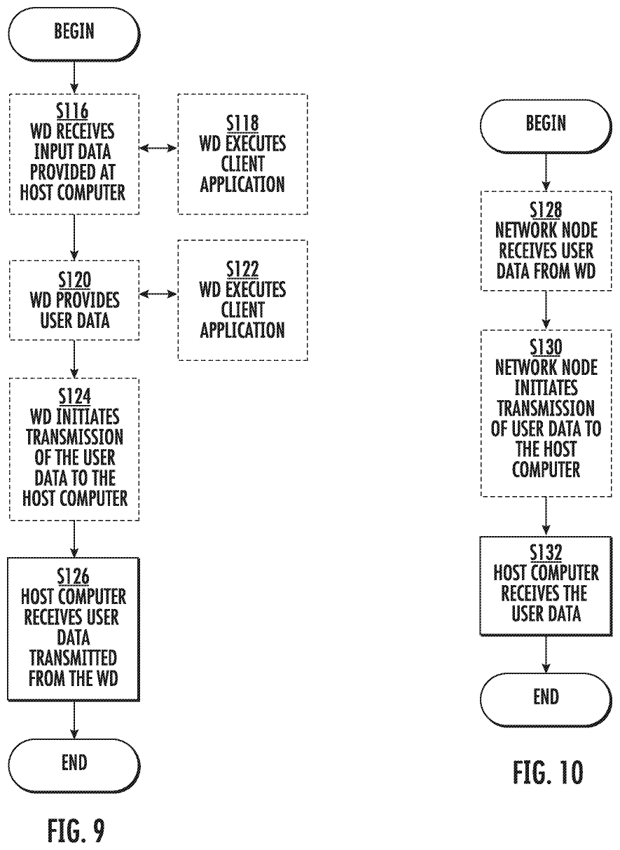

FIG. 9 is a flowchart illustrating an example method implemented in a communication system, such as, for example, the communication system of FIG. 5, in accordance with one embodiment. The communication system may include a host computer 24, a network node 16 and a WD 22, which may be those described with reference to FIGS. 5 and 6. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 10 is a flowchart illustrating an example method implemented in a communication system, such as, for example, the communication system of FIG. 5, in accordance with one embodiment. The communication system may include a host computer 24, a network node 16 and a WD 22, which may be those described with reference to FIGS. 5 and 6. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

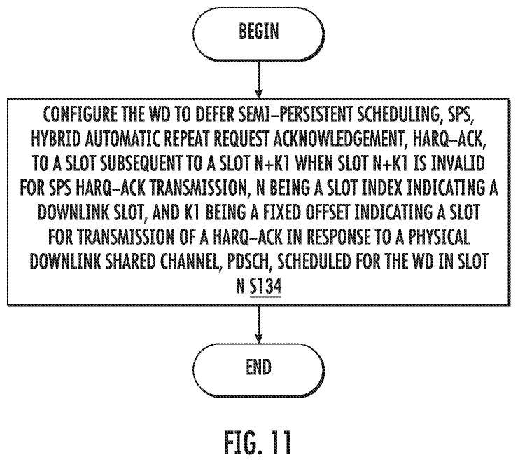

FIG. 11 is a flowchart of an example process in a network node 16 for deferring semipersistent scheduling (SPS) hybrid automatic repeat request acknowledgements (HARQ-ACK). One or more blocks described herein may be performed by one or more elements of network node 16 such as by one or more of processing circuitry 68 (including the configuration unit 32), processor 70, radio interface 62 and/or communication interface 60. Network node 16 such as via processing circuitry 68 and/or processor 70 and/or radio interface 62 and/or communication interface 60 is configured to configure the WD to defer semi-persistent scheduling, SPS, hybrid automatic repeat request acknowledgement, HARQ-ACK, to a slot subsequent to a slot n+K1 when slot n+K1 is invalid for SPS HARQ-ACK transmission, n being a slot index indicating a downlink slot, and K1 being a fixed offset indicating a slot for transmission of a HARQ-ACK in response to a physical downlink shared channel, PDSCH, scheduled for the WD in slot n (Block S134).

In some embodiments, deferral of SPS HARQ-ACK is limited to a predetermined maximum number of slots. In some embodiments, the method includes indicating to the WD a subset of symbols in a slot as invalid for deferred SPS HARQ-ACK. In some embodiments, the subset of invalid symbols are configured per WD. In some embodiments, the subset of invalid symbols are configured per SPS configuration. In some embodiments, a slot format indication, SFI, is disabled from causing the SPS HARQ-ACK deferring. In some embodiments, the method also includes receiving deferred SPS HARQ-ACK bits that are multiplexed with other HARQ-ACK bits in response to multiple transmissions to the WD. In some embodiments, the method also includes determining a physical uplink control channel, PUCCH, resource based at least in part on a total size of a payload of multiplexed HARQ-ACK bits. In some embodiments, the method also includes configuring the WD to drop deferred SPS HARQ-ACK when the WD cannot transmit on a physical uplink control channel, PUCCH, resource within a slot to which the SPS HARQ-ACK is deferred. In some embodiments, the subsequent slot is a first available slot subsequent to slot n+K1. In some embodiments, a fraction of SPS HARQ-ACK bits for a HARQ-ACK code book, CB, are deferred to a first available slot subsequent to slot n+K1 and a remainder of SPS HARQ-ACK bits for the HARQ-ACK CB are deferred to a slot subsequent to the first available slot.

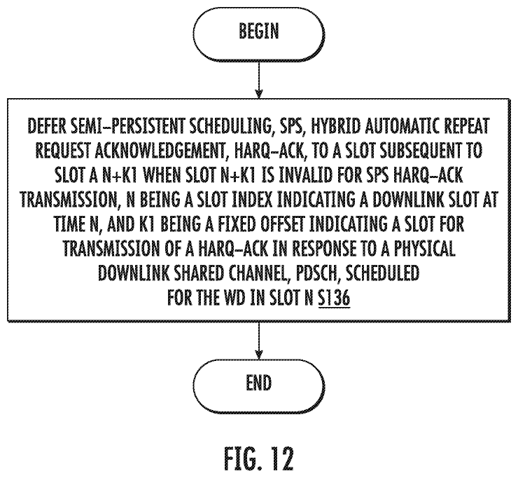

FIG. 12 is a flowchart of an example process in a wireless device 22 according to some embodiments of the present disclosure. One or more blocks described herein may be performed by one or more elements of wireless device 22 such as by one or more of processing circuitry 84 (including the deferral unit 34), processor 86, radio interface 82 and/or communication interface 60. Wireless device 22 such as via processing circuitry 84 and/or processor 86 and/or radio interface 82 is configured to defer semi-persistent scheduling, SPS, hybrid automatic repeat request acknowledgement, HARQ-ACK, to a slot subsequent to slot a n+K1 when slot n+K1 is invalid for SPS HARQ-ACK transmission, n being a slot index indicating a downlink slot and K1 being a fixed offset indicating a slot for transmission of a HARQ-ACK in response to a physical downlink shared channel, PDSCH, scheduled for the WD in slot n (Block S136).

In some embodiments, deferral of SPS HARQ-ACK is limited to a predetermined maximum number of slots. In some embodiments, the slot subsequent to the slot n+K1 is a first available slot that is not a downlink slot. In some embodiments, the method also includes dropping an SPS HARQ-ACK when the SPS HARQ-ACK cannot be transmitted before a slot n+K, where K>K1. In some embodiments, the WD is further configured to drop the deferred SPS HARQ-ACK when a physical uplink control channel, PUCCH, resource overlaps with invalid symbols. In some embodiments, the method also includes multiplexing deferred SPS HARQ-ACK bits with other HARQ-ACK bits in response to multiple transmissions received from the network node. In some embodiments, the method also includes determining a physical uplink control channel, PUCCH, resource based at least in part on a total size of a payload of multiplexed HARQ-ACK bits.

Having described the general process flow of arrangements of the disclosure and having provided examples of hardware and software arrangements for implementing the processes and functions of the disclosure, the sections below provide details and examples of arrangements for deferring semipersistent scheduling (SPS) hybrid automatic repeat request acknowledgements (HARQ-ACK).

In the following embodiments, solutions are described using the term “slot” as a resource unit by which HARQ-ACK feedback is transmitted. It is noted that these solutions can equally apply to cases where HARQ-ACK feedback transmission is in a sub-slot, in a slot with duration less than 14 symbols, or associated with sub-slot configuration.

### Determination of a Slot to Use for Deferred SPS HARQ-ACK

In one non-limiting embodiment, when SPS HARQ-ACK corresponding to SPS PDSCH transmitted in slot n is determined from the HARQ-ACK feedback timing to be transmitted in slot n+K1 which is invalid, e.g., slot n+K1 is a DL slot, the SPS HARQ-ACK is instead transmitted in the first available slot after slot n+K1 which contains any valid symbols. The SPS HARQ-ACK transmitted in a later slot than slot n+K1 is referred to as deferred SPS HARQ-ACK.

In one version of the above embodiment, the valid symbols include UL symbols and flexible symbols as configured by a semi-statically configured TDD pattern. DL symbols are considered as invalid

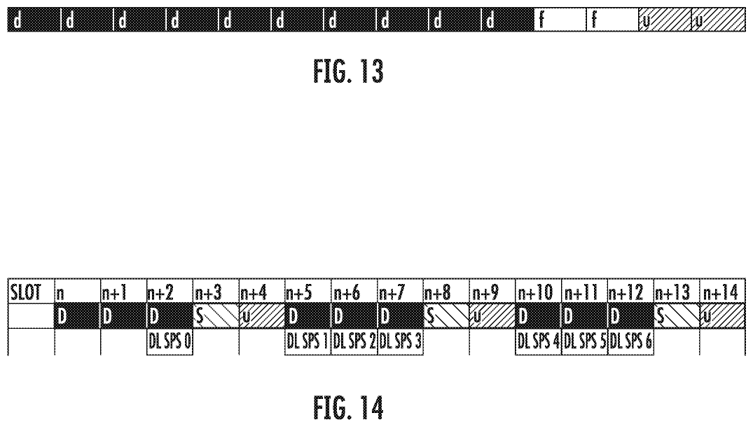

FIG. 13 is an example of a special slot containing 10 DL symbols, 2 flexible symbols and 2 uplink symbols. FIG. 14 illustrates the above embodiments. FIG. 14 shows DL SPS with periodicity of one slot and slot timing value K1=1. Assume that DL SPS is activated from slot n+2. HARQ-ACK corresponding to DL SPS 0 can be sent in slot n+3 as determined by K1=1 as the slot n+3 is a special slot containing valid symbols (flexible and UL symbols), as shown in FIG. 13. HARQ-ACK corresponding to DL SPS 1 and 2 are not sent in slot n+6 and n+7 since they do not contain any valid symbol. Instead, they are “deferred” and sent in slot n+8 as this slot is the first slot which contains valid symbols for deferred SPS HARQ-ACK.

In one version of the above embodiment, the SPS HARQ-ACK which was previously determined to be transmitted in slot n+K1 in response to SPS PDSCH transmitted in slot n is dropped if it cannot be transmitted before or at a slot n+K, where K>K1, i.e., there are no valid symbols in slots n+K1+1, n+K1+2, . . . , n+K. In other words, the SPS HARQ-ACK cannot be deferred for more than K−K1 slots. The value K can be fixed in the specification or configured to a WD 22 or indicated as part of WD 22 capability signaling. In case K is fixed in the specification, it can be fixed to the maximum value in the set of configured K1 values.

### Configuration of Invalid Symbols/Slot for Deferred SPS HARQ-ACK

In one non-limiting embodiment, a subset of symbols in a slot can be configured as invalid for the deferred SPS HARQ-ACK. This is illustrated by the example in FIG. 15.

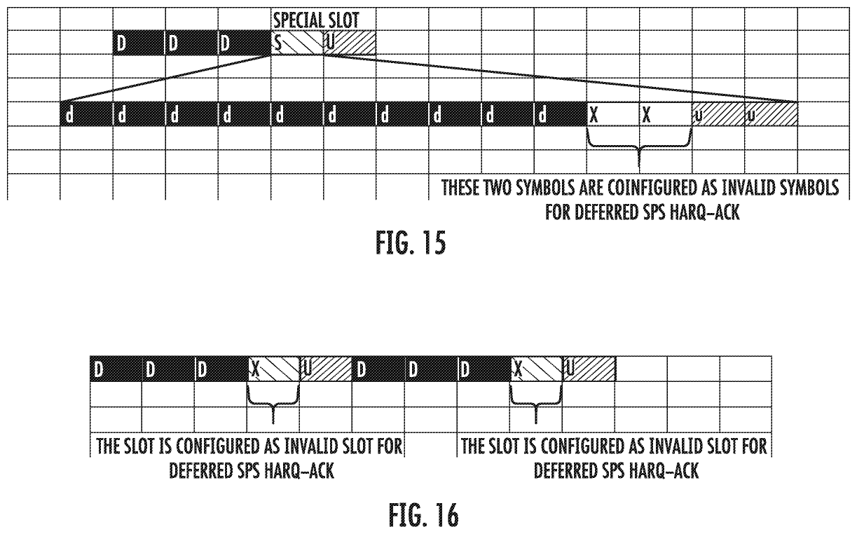

In another non-limiting embodiment, a set of slots can be configured as invalid for the deferred SPS HARQ-ACK. This is illustrated by the example in FIG. 16.

When determining a slot to use for the deferred SPS HARQ-ACK as described in the section entitled, “Determination of a slot to use for deferred SPS HARQ-ACK,” whether a slot is considered as containing any valid symbols also depends on the configured invalid symbols or slots in the above embodiments.

In one version of the above embodiment, the set of invalid symbols/slot for deferred SPS HARQ-ACK is configured per WD 22 and applied to all SPS configurations. In one version of the above embodiment, the set of invalid symbols/slot for deferred SPS HARQ-ACK is configured per SPS configuration. In this case, the configured invalid symbols/slots can be activated at the same time when a SPS configuration is activated. In one version of the above embodiment, configuration of the set of invalid symbols/slot for deferred SPS HARQ-ACK is done through a bitmap where each bit corresponds to a slot or a symbol in a slot. The bitmap indicating invalid symbols/slot for deferred SPS HARQ-ACK can be considered as periodic where the period equals to the bitmap length.

Interaction with Slot Format Indication (SFI)

In one non-limiting embodiment, the SFI is not permitted to cause SPS HARQ-ACK deferring.

If the WD 22 detects the SFI making the SPS HARQ-ACK to collide with invalid symbols, the SPS HARQ-ACK transmission is dropped or cancelled.

### Multiplexing of HARQ-ACK Bits Including Deferred SPS HARQ-ACK

### PUCCH Resource Determination

In one non-limiting embodiment, when the deferred SPS HARQ-ACK is multiplexed with other HARQ-ACK bits, a PUCCH resource is determined based on the total payload size. In one non-limiting embodiment, when the deferred SPS HARQ-ACK is multiplexed with other HARQ-ACK bits, a PUCCH resource is determined based on whether the other HARQ-ACK bits are HARQ-ACK corresponding to SPS PDSCH or dynamically scheduled PDSCH.

If the deferred SPS HARQ-ACK is multiplexed with other HARQ-ACK bits in response to one or more SPS receptions, then a PUCCH resource to use for the multiplexed HARQ-ACK bits may be determined from the set of configured PUCCH resources for SPS HARQ-ACK, e.g., if a WD 22 is provided SPS-PUCCH-AN-List-r16, a PUCCH resource may be determined by sps-PUCCH-AN-ResourceID as defined in the current 3GPP specification.

If the deferred SPS HARQ-ACK is multiplexed with other HARQ-ACK bits in response to dynamically scheduled PDSCH, then a PUCCH resource to use may be determined by pucch-ResourceSetId in the configured PUCCH-ResourceSet.

WD Behavior when a PUCCH Resource Determined for Multiplexed HARQ-ACK Becomes Invalid

In another non-limiting embodiment, if the deferred SPS HARQ-ACK bits are multiplexed with other HARQ-ACK bits (in response to SPS PDSCH or dynamically scheduled PDSCH) scheduled or configured to be transmitted in a slot, and the newly determined PUCCH resource cannot be transmitted within the slot, e.g., due to collision with invalid symbols, then a WD 22 is not expected to multiplex the deferred SPS HARQ-ACK. The WD 22 instead may be configured to:
drop the deferred SPS HARQ-ACK, and transmit the other HARQ-ACK bits; or
transmit the deferred SPS HARQ-ACK and drop the other HARQ-ACK bits; or
treat this as an error case where nothing is transmitted.

### Type-1 HARQ-ACK Codebook Containing the Deferred SPS HARQ-ACK

In one non-limiting embodiment, when SPS HARQ-ACK is allowed to be deferred up to K slots after a slot corresponding to where SPS PDSCH ends, and K is larger than the maximum value Kmax in the set of configured slot timing values K1, then the WD 22 may determine a set of occasions for candidate PDSCH receptions for which the WD 22 can transmit corresponding HARQ-ACK information in Type-1 HARQ-ACK codebook based on the extended set of K1. The extended set of K1 includes Kmax+1, Kmax+2, . . . K as new values in the set.

### Example of a Complete SPS HARQ-ACK Deferring Procedure

In the following, one example of complete SPS HARQ-ACK deferring procedure, consisting of multiple steps described in the previous embodiments is provided.

These example steps are as follows:
1. While a WD 22 determines a HARQ-ACK codebook (CB) to be transmitted in slot n:
   a. If the CB includes only HARQ-ACK corresponding to DL SPS:
      i. If the slot/sub-slot does not include any available/valid symbol for a PUCCH transmission, proceed to the next slot (je increment n by one) [See Embodiments disclosed in the sections entitled “Determination of a slot to use for deferred SPS HARQ-ACK” and “Configuration of invalid symbols/slot for deferred SPS HARQ-ACK” ] Then go to step 1;
      ii. Otherwise, based on the size of HARQ-ACK CB or the total HARQ-ACK payload size, determine the PUCCH resource for transmission of HARQ-ACK CB following 3GPP Rel-16 procedures [See Embodiments disclosed in the section entitled, “PUCCH Resource Determination” ];
         If there are available symbols for transmission of the PUCCH resource in slot/subslot n, transmit the PUCCH;
         Otherwise, cancel the PUCCH transmission. [See Embodiments disclosed herein in the section entitled “UE behavior when a PUCCH resource determined for multiplexed HARQ-ACK becomes invalid” ];
   b. Otherwise, follow already existing procedures for transmission of the HARQ-ACK CB;
2. End while.

### Non-Overflow Deferring Vs Overflow Deferring

Denote as follows:
Default HARQ-ACK bits: These are HARQ-ACK bits which are supposed to be transmitted in a PUCCH resource located at pointer K1 with respect to an SPS occasion. K1 is mentioned in scheduling/activation DCI or deduced using a combination of DCI plus radio resource control (RRC) configuration; and
Deferred HARQ-ACK bits: These are HARQ-ACK bits, if the WD 22 is unable to transmit in the PUCCH resource located at K1 with respect to DL occasions, and thus HARQ-ACK bits transmission are deferred to slots >K1.

In one non-limiting embodiment, if there are deferred HARQ-ACK bits, they are to be transmitted in the nearest PUCCH resource such that the whole CB can be transmitted including the default HARQ-ACK bits and the deferred HARQ-ACK bits. For example, for the some SPS occasions in the slots, their default HARQ-ACK feedback points to slot S1, for example, there are N number of HARQ-ACK bits to be transmitted on slot S1's PUCCH resource. However, if slot S1 is not configured as UL, these default HARQ-ACK bits should be deferred to nearest slot with valid PUCCH resource, in some embodiments. Assume these N HARQ-ACK bits are deferred to slot S1+a; now in slot S1+a, there is already a PUCCH resource configured for transmission of X default HARQ-ACK bits (this excludes deferred bits), but now with deferred bits in this slot, the CB size increases to X+N.

It is noted that in previous embodiments, the WD 22 can transmit deferred bits in the slot S1+a, only if whole CB with size X+N can be transmitted. If there is overflowing, then the X+N bits cannot be fit in the CB, and the section above entitled, “UE behavior when a PUCCH resource determined for multiplexed HARQ-ACK becomes invalid” applies.

Alternatively, all the bits X+N can be deferred to a nearest slot. Thus, the WD 22 may defer the HARQ-ACK bits to the slot where it can fit all the HARQ-ACK bits in the CB, including both default and deferred HARQ-ACK bits. Note, in the above that symbols S1, a, X, and N are to be assumed to be natural numbers. Denote this solution, “non-overflow deferring.”

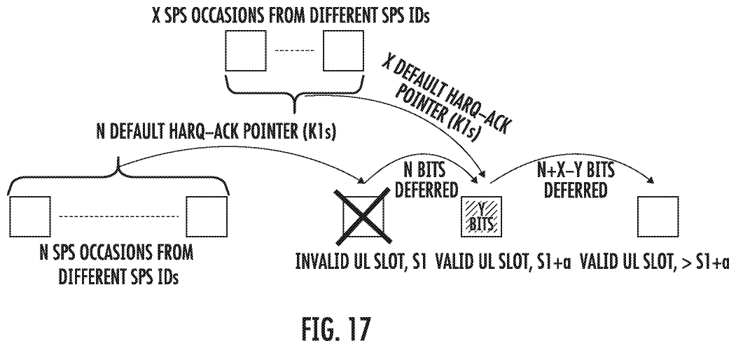

Another method is disclosed as follows and is referred to as “overflow deferring”. Continuing with the above example, in slot S1+a, if WD 22 cannot fit all the X+N HARQ-ACK bits, then let us assume the maximum HARQ-ACK bits WD 22 can fit is Y where Y<X+N. Then the WD 22 will fit the first Y bits from X+N bits according to their SPS occasion timing. This may mean that the earlier the occasion is, the HARQ-bit for that occasion will be preferred over the HARQ-ACK bit for an SPS occasion that comes later. This may ensure that an out-of-order rule is not broken. Thus, the WD 22 may transmit CB of size Y in slot S1+a, and the remaining X+N-Y bits, i.e., overflow bits will be deferred to a nearest possible slot with valid PUCCH resource (i.e., slot >S1+a). Then the procedure will continue. See FIG. 17 for a pictorial representation of the algorithm.

In the example of FIG. 17, when deferred HARQ-ACK bits are pushed in the nearest valid PUCCH resource, the whole CB may not fit, causing overflowing HARQ-ACK information bits, i.e., N+X-Y are deferred to the next possible valid PUCCH resource. Note that when the CB is transmitted over slot S1+a, it has Y bits which should be inserted according to their PDSCHs' timeline so that out-of-order rule is not broken, in some embodiments.

The following table summarizes at least some of the differences between the non-overflow deferring mode and the overflow deferring mode.

| | Non-overflow deferring | Overflow deferring |
|---|---|---|
| Advantages | Higher latency for | Lower latency for |
| | the deferred | deferred bits, as |
| | HARQ-ACK bits | they take |
| | due to the | precedence in the |
| | condition that | nearest slot, and |
| | whole CB | the overflow |
| | including both | HARQ-ACK bits |
| | deferred and | are deferred |
| | default bits must | Here CB may be |
| | be fit in a slot | more complex, as |
| | wholly. | the deferred bits |
| | The CB | are always filled |
| | construction may | first in the CB, and |
| | appear simple, as | if there is |
| | deferred bits can | overflow, those |
| | be put in the CB | bits are deferred to |
| | anywhere (but | the next possible |
| | there may be a rule | slot. By this, an |
| | which both | out-of-order rule |
| | network node 16 | for HARQ-ACK |
| | and WD 22 know) | transmission is |
| | because an | maintained. |
| | objective may be | |
| | to transmit the | |
| | whole CB with | |
| | deferred and | |
| | default bits, e.g., | |
| | all the deferred bits | |
| | can be appended in | |
| | the end or at the | |
| | beginning, etc. | |

Both modes can be implemented depending on the scenario. They both have pros and cons. The “non-overflow deferring” solution provides easier CB construction, whereas the “overflow deferring” solution provides low latency for deferred HARQ-ACK bits. Therefore, to utilize both, a higher layer parameter can be configured (which may be called HARQbitsOverflow). When HARQbitsOverflow is enabled, the WD 22 does CB construction based on the “overflow deferring” solution and if HARQbitsOverflow is disabled, the WD 22 does CB construction based on the “non-overflow deferring” solution.

According to one aspect, a network node 16 is configured to communicate with a wireless device (WD) 22. The network node 16 includes a radio interface 62 and/or comprising processing circuitry 68 configured to configure the WD 22 to defer semi-persistent scheduling (SPS) hybrid automatic repeat request acknowledgement (HARQ-ACK) to a slot subsequent to slot n+K1 when slot n+K1 is a downlink slot, where n is a slot index indicating a downlink slot at n, and K1 is a fixed offset used to indicate a slot for transmission of a HARQ-ACK when the slot n+K1 is not a downlink slot.

According to this aspect, in some embodiments, a subset of symbols in a slot are configured as invalid for deferred SPS HARQ-ACK. In some embodiments, the set of invalid symbols are configured per WD 22. In some embodiments, the set of invalid symbols are configured per SPS configuration. In some embodiments, the deferring is one of non-overflow deferring and overflow deferring. In some embodiments, a slot format indication (SFI) is disabled from causing the SPS HARQ-ACK deferring. In some embodiments, a physical uplink control channel (PUCCH) resource is determined based on a total size of a payload when deferred SPS HARQ-ACK is multiplexed with other HARQ-ACK bits.

According to this aspect, a method implemented in a network node 16 includes configuring the WD 22 to defer semi-persistent scheduling (SPS) hybrid automatic repeat request acknowledgement (HARQ-ACK) to a slot subsequent to slot n+K1 when slot n+K1 is a downlink slot, where n is a slot index indicating a downlink slot at n, and K1 is a fixed offset used to indicate a slot for transmission of a HARQ-ACK when the slot n+K1 is not a downlink slot.

According to this aspect, in some embodiments, a subset of symbols in a slot are configured as invalid for deferred SPS HARQ-ACK. In some embodiments, the set of invalid symbols are configured per WD 22. In some embodiments, the set of invalid symbols are configured per SPS configuration. In some embodiments, the deferring is one of non-overflow deferring and overflow deferring. In some embodiments, a slot format indication (SFI) is disabled from causing the SPS HARQ-ACK deferring. In some embodiments, a physical uplink control channel (PUCCH) resource is determined based on a total size of a payload when deferred SPS HARQ-ACK is multiplexed with other HARQ-ACK bits.

According to yet another aspect, a WD 22 is configured to communicate with a network node 16. The WD 22 includes a radio interface 82 and/or processing circuitry 84 configured to defer semi-persistent scheduling (SPS) hybrid automatic repeat request acknowledgement (HARQ-ACK) to a slot subsequent to slot n+K1 when slot n+K1 is a downlink slot, where n is a slot index indicating a downlink slot at time n, and K1 is a fixed offset used to indicate a slot for transmission of a HARQ-ACK when the slot n+K1 is not a downlink slot.

According to this aspect, in some embodiments, the slot subsequent to the slot n+K1 is a first available slot that is not a downlink slot. In some embodiments, the SPS HARQ-ACK is dropped if the SPS HARQ-ACK cannot be transmitted before a slot n+K, where K>K1. In some embodiments, the deferring is one of non-overflow deferring and overflow deferring. In some embodiments, a slot format indication (SFI) is disabled from causing the SPS HARQ-ACK deferring. In some embodiments, a physical uplink control channel (PUCCH) resource is determined based on a total size of a payload when deferred SPS HARQ-ACK is multiplexed with other HARQ-ACK bits. In some embodiments, the deferred SPS HARQ-ACK is dropped from the multiplexing or the other HARQ-ACK bits are dropped from the multiplexing when the determined PUCCH resource cannot be transmitted within a slot.

According to another aspect, a method implemented in a wireless device (WD) 22 includes deferring semi-persistent scheduling (SPS) hybrid automatic repeat request acknowledgement (HARQ-ACK) to a slot subsequent to slot n+K1 when slot n+K1 is a downlink slot, where n is a slot index indicating a downlink slot at time n, and K1 is a fixed offset used to indicate a slot for transmission of a HARQ-ACK when the slot n+K1 is not a downlink slot.

According to this aspect, in some embodiments, the slot subsequent to the slot n+K1 is a first available slot that is not a downlink slot. In some embodiments, the SPS HARQ-ACK is dropped if the SPS HARQ-ACK cannot be transmitted before a slot n+K, where K>K1. In some embodiments, the deferring is one of non-overflow deferring and overflow deferring. In some embodiments, a slot format indication (SFI) is disabled from causing the SPS HARQ-ACK deferring. In some embodiments, a physical uplink control channel (PUCCH) resource is determined based on a total size of a payload when deferred SPS HARQ-ACK is multiplexed with other HARQ-ACK bits. In some embodiments, the deferred SPS HARQ-ACK is dropped from the multiplexing or the other HARQ-ACK bits are dropped from the multiplexing when the determined PUCCH resource cannot be transmitted within a slot.

Some examples may include one or more of the following:
Example A1. A network node 16 configured to communicate with a wireless device 22 (WD 22), the network node 16 configured to, and/or comprising a radio interface 62 and/or comprising processing circuitry 68 configured to:
configure the WD 22 to defer semi-persistent scheduling (SPS) hybrid automatic repeat request acknowledgement (HARQ-ACK) to a slot subsequent to slot n+K1 when slot n+K1 is a downlink slot, where n is a slot index indicating a downlink slot at n, and K1 is a fixed offset used to indicate a slot for transmission of a HARQ-ACK when the slot n+K1 is not a downlink slot.
Example A2. The network node 16 of Example A1, wherein a subset of symbols in a slot are configured as invalid for deferred SPS HARQ-ACK.
Example A3. The network node 16 of Example A2, wherein the set of invalid symbols are configured per WD 22.
Example A4. The network node 16 of Example A2, wherein the set of invalid symbols are configured per SPS configuration.
Example A5. The network node 16 of Example A1, wherein the deferring is one of non-overflow deferring and overflow deferring.
Example A6. The network node 16 of any of Examples A1-A5, wherein a slot format indication (SFI) is disabled from causing the SPS HARQ-ACK deferring.
Example A7. The network node 16 of any of Examples A1-A6, wherein a physical uplink control channel (PUCCH) resource is determined based on a total size of a payload when deferred SPS HARQ-ACK is multiplexed with other HARQ-ACK bits.
Example B1. A method implemented in a network node 16, the method comprising:
configuring the WD 22 to defer semi-persistent scheduling (SPS) hybrid automatic repeat request acknowledgement (HARQ-ACK) to a slot subsequent to slot n+K1 when slot n+K1 is a downlink slot, where n is a slot index indicating a downlink slot at n, and K1 is a fixed offset used to indicate a slot for transmission of a HARQ-ACK when the slot n+K1 is not a downlink slot.
Example B2. The method of Example B1, wherein a subset of symbols in a slot are configured as invalid for deferred SPS HARQ-ACK.
Example B3. The method of Example B2, wherein the set of invalid symbols are configured per WD 22.
Example B4. The method of Example B2, wherein the set of invalid symbols are configured per SPS configuration.
Example B5. The method of Example B1, wherein the deferring is one of non-overflow deferring and overflow deferring.
Example B6. The method of any of Examples B1-B5, wherein a slot format indication (SFI) is disabled from causing the SPS HARQ-ACK deferring.
Example B7. The method of any of Examples B1-B6, wherein a physical uplink control channel (PUCCH) resource is determined based on a total size of a payload when deferred SPS HARQ-ACK is multiplexed with other HARQ-ACK bits.
Example C1. A wireless device 22 (WD 22) configured to communicate with a network node 16, the WD 22 configured to, and/or comprising a radio interface 82 and/or processing circuitry 84 configured to:
defer semi-persistent scheduling (SPS) hybrid automatic repeat request acknowledgement (HARQ-ACK) to a slot subsequent to slot n+K1 when slot n+K1 is a downlink slot, where n is a slot index indicating a downlink slot at time n, and K1 is a fixed offset used to indicate a slot for transmission of a HARQ-ACK when the slot n+K1 is not a downlink slot.
Example C2. The WD 22 of Example C1, wherein the slot subsequent to the slot n+K1 is a first available slot that is not a downlink slot.
Example C3. The WD 22 of Example C1, wherein the SPS HARQ-ACK is dropped if the SPS HARQ-ACK cannot be transmitted before a slot n+K, where K>K1.
Example C4. The WD 22 of Example C1, wherein the deferring is one of non-overflow deferring and overflow deferring.
Example C5. The WD 22 of any of Examples C1-C4, wherein a slot format indication (SFI) is disabled from causing the SPS HARQ-ACK deferring.
Example C6. The WD 22 of any of Examples C1-C5, wherein a physical uplink control channel (PUCCH) resource is determined based on a total size of a payload when deferred SPS HARQ-ACK is multiplexed with other HARQ-ACK bits.
Example C7. The WD 22 of Example C6, wherein the deferred SPS HARQ-ACK is dropped from the multiplexing or the other HARQ-ACK bits are dropped from the multiplexing when the determined PUCCH resource cannot be transmitted within a slot.
Example D1. A method implemented in a wireless device 22 (WD 22), the method comprising:
deferring semi-persistent scheduling (SPS) hybrid automatic repeat request acknowledgement (HARQ-ACK) to a slot subsequent to slot n+K1 when slot n+K1 is a downlink slot, where n is a slot index indicating a downlink slot at time n, and K1 is a fixed offset used to indicate a slot for transmission of a HARQ-ACK when the slot n+K1 is not a downlink slot.
Example D2. The method of Example D1, wherein the slot subsequent to the slot n+K1 is a first available slot that is not a downlink slot.
Example D3. The method of Example D1, wherein the SPS HARQ-ACK is dropped if the SPS HARQ-ACK cannot be transmitted before a slot n+K, where K>K1.
Example D4. The method of Example D1, wherein the deferring is one of non-overflow deferring and overflow deferring.
Example D5. The method of any of Examples D1-D4, wherein a slot format indication (SFI) is disabled from causing the SPS HARQ-ACK deferring.
Example D6. The method of any of Examples D1-D4, wherein a physical uplink control channel (PUCCH) resource is determined based on a total size of a payload when deferred SPS HARQ-ACK is multiplexed with other HARQ-ACK bits.
Example D7. The method of Example D6, wherein the deferred SPS HARQ-ACK is dropped from the multiplexing or the other HARQ-ACK bits are dropped from the multiplexing when the determined PUCCH resource cannot be transmitted within a slot.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in
the preceding description include:

| Abbreviations | Explanation |
|---|---|
| CC | Component Carrier |
| CCE | Control Channel Element |
| CSI | Channel State Information |
| DCI | Downlink Control Information |
| FDM | Frequency Division Multiplexing |
| HARQ-ACK | Hybrid automatic repeat request Acknowledgement |
| PDCCH | Physical Downlink Control Channel |
| PDSCH | Physical Downlink Shared Channel |
| PUCCH | Physical Uplink Control Channel |
| PUSCH | Physical Uplink Shared Channel |
| SPS | Semi-Persistent Scheduling |
| SR | Scheduling Request |
| TDM | Time Division Multiplexing |
| TDD | Time Division Duplex |
| TRP | Transmission Reception Point |
| UCI | Uplink control information |
| UL | Uplink |
| URLLC | Ultra -Reliable Low-Latency Communication |
| WD | Wireless Device |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A network node configured to communicate with a wireless device, WD, the network node configured to:
configure the WD to defer semi-persistent scheduling, SPS, hybrid automatic repeat request acknowledgement, HARQ-ACK, to a slot subsequent to a slot n+K1 when slot n+K1 is invalid for SPS HARQ-ACK transmission, n being a slot index indicating a downlink slot, and K1 being a fixed offset indicating a slot for transmission of a HARQ-ACK in response to a physical downlink shared channel, PDSCH, scheduled for the WD in slot n.

2. (canceled)

3. The network node of claim 1, wherein the network node is further configured to indicate to the WD a subset of symbols in a slot as invalid for deferred SPS HARQ-ACK.

4. The network node of claim 3, wherein the subset of invalid symbols are configured per WD.

5. The network node of claim 3, wherein the subset of invalid symbols are configured per SPS configuration.

6. (canceled)

7. (canceled)

8. The network node of claim 1, wherein the network node is configured to determine a physical uplink control channel, PUCCH, resource based at least in part on a total size of a payload of multiplexed HARQ-ACK bits.

9. The network node of claim 1, wherein the network node is configured to configure the WD to drop deferred SPS HARQ-ACK when the WD cannot transmit on a physical uplink control channel, PUCCH, resource within a slot to which the SPS HARQ-ACK is deferred.

10. (canceled)

11. (canceled)

12. A method implemented in a network node configured to communicate with a wireless device, WD, the method comprising:
configuring the WD to defer semi-persistent scheduling, SPS, hybrid automatic repeat request acknowledgement, HARQ-ACK, to a slot subsequent to a slot n+K1 when slot n+K1 is invalid for SPS HARQ-ACK transmission, n being a slot index indicating a downlink slot, and K1 being a fixed offset indicating a slot for transmission of a HARQ-ACK in response to a physical downlink shared channel, PDSCH, scheduled for the WD in slot n.

13. (canceled)

14. The method of claim 12, further comprising indicating to the WD a subset of symbols in a slot as invalid for deferred SPS HARQ-ACK.

15. The method of claim 14, wherein the subset of invalid symbols are configured per WD.

16. The method of claim 14, wherein the subset of invalid symbols are configured per SPS configuration.

17. (canceled)

18. (canceled)

19. The method of claim 12, further comprising determining a physical uplink control channel, PUCCH, resource based at least in part on a total size of a payload of multiplexed HARQ-ACK bits.

20. The method of claim 12, further comprising configuring the WD to drop deferred SPS HARQ-ACK when the WD cannot transmit on a physical uplink control channel, PUCCH, resource within a slot to which the SPS HARQ-ACK is deferred.

21. (canceled)

22. (canceled)

23. A wireless device, WD, configured to communicate with a network node, the WD configured to:
defer semi-persistent scheduling, SPS, hybrid automatic repeat request acknowledgement, HARQ-ACK, to a slot subsequent to a slot n+K1 when slot n+K1 is invalid for SPS HARQ-ACK transmission, n being a slot index indicating a downlink slot and K1 being a fixed offset indicating a slot for transmission of a HARQ-ACK in response to a physical downlink shared channel, PDSCH, scheduled for the WD in slot n.

24. (canceled)

25. The WD of claim 23, wherein the slot subsequent to the slot n+K1 is a first available slot that is not a downlink slot.

26. The WD of claim 23, wherein the WD is further configured to drop the SPS HARQ-ACK when the SPS HARQ-ACK cannot be transmitted before a slot n+K, where K>K1.

27. (canceled)

28. (canceled)

29. The WD of claim 23, wherein the WD is configured to determine a physical uplink control channel, PUCCH, resource based at least in part on a total size of a payload of multiplexed HARQ-ACK bits.

30. A method implemented in a wireless device, WD, configured to communicate with a network node, the method comprising:
deferring semi-persistent scheduling, SPS, hybrid automatic repeat request acknowledgement, HARQ-ACK, to a slot subsequent to a slot n+K1 when slot n+K1 is invalid for SPS HARQ-ACK transmission, n being a slot index indicating a downlink slot and K1 being a fixed offset indicating a slot for transmission of a HARQ-ACK in response to a physical downlink shared channel, PDSCH, scheduled for the WD in slot n.

31. (canceled)

32. The method of claim 30, wherein the slot subsequent to the slot n+K1 is a first available slot that is not a downlink slot.

33. The method of claim 30, further comprising dropping an SPS HARQ-ACK when the SPS HARQ-ACK cannot be transmitted before a slot n+K, where K>K1.

34. (canceled)

35. (canceled)

36. The method of claim 30, further comprising determining a physical uplink control channel, PUCCH, resource based at least in part on a total size of a payload of multiplexed HARQ-ACK bits.
